(19) United States
(12) Patent Application Publication
(10) Pub. No.: US 2023/0311981 A1
(43) Pub. Date: Oct. 5, 2023

(54) METHOD FOR DETERMINING A REGULATED MANUAL TORQUE AND STEERING SYSTEM

(71) Applicant: ZF AUTOMOTIVE GERMANY GMBH, ALFDORF (DE)

(72) Inventor: Philipp Bergmann, Duesseldorf (DE)

(21) Appl. No.: 18/189,591

(22) Filed: Mar. 24, 2023

(30) Foreign Application Priority Data
Mar. 30, 2022 (DE) 102022203129.6

(51) Int. Cl. B62D 6/00

(52) U.S. Cl. CPC B62D 6/008

(57) ABSTRACT

A method is specified for determining a regulated manual torque for a steer-by-wire steering system, which works against a steering torque applied by a driver to a steering wheel. The manual torque is regulated as a reference variable, which results from summed output values of at least two functions, wherein a first function of the at least two functions is dominant over a second function of the at least two functions, and wherein an output value of the first, dominating function acts as a control variable on the second function. Furthermore, a steering system is specified.

### CROSS-REFERENCE TO RELATED APPLICATION

This application claims priority to German Priority Application No. 102022203129.6, filed Mar. 30, 2022, the disclosure of which is incorporated herein by reference in its entirety.

### TECHNICAL FIELD

The disclosure relates to a method for determining a regulated manual torque for a steer-by-wire steering system, which works against a steering torque applied by a driver to a steering wheel, and to a steering system. In particular, the manual torque is designed as a feedback torque. The feedback torque or else manual torque can have, inter alia, a damping component here. The manual torque or feedback torque can be designated or designed as an overall manual torque or overall feedback torque.

### BACKGROUND

In steer-by-wire steering systems, a steering angle of the steering wheel is electronically detected. To achieve stable steering behavior, the movement of the steering wheel is damped. For this purpose, a torque is applied to the steering wheel, which works against the steering movement of the driver.

Based on the electronically detected steering angle, a wheel steer angle is set by a servomotor on the front axle.

In steer-by-wire steering systems, there is no mechanical coupling between steering wheel and wheels, so that theoretically an arbitrary transmission ratio of a steering angle to a wheel steering angle can be set. However, the movement travel of the servomotor on the front axle is limited. A maximum steering angle therefore results from the maximum movement travel of the servomotor in combination with the transmission ratio of the steering angle to the wheel steering angle.

As soon as the maximum steering angle is reached, a further steering movement beyond the maximum steering angle is to be prevented. For this purpose, a torque acting on the steering wheel is significantly increased as soon as the steering angle approaches the maximum steering angle.

It is disadvantageous in this case that an abrupt increase of the torque acting on the steering wheel occurs upon an approach to the maximum steering angle.

### SUMMARY

What is needed is to regulate a torque applied to the steering wheel in such a way that a fluid rise or fall of the torque takes place when steering in a range close to the maximum steering angle.

A method for determining a regulated manual torque for a steer-by-wire steering system is disclosed, which works against a steering torque applied by a driver to a steering wheel. The manual torque is regulated as a reference variable or is regulated based on a reference variable, which results from the summed output values of at least two functions, wherein a first function of the at least two functions is dominating over a second function of the at least two functions, and wherein an output value of the first, dominating function acts as an input variable of the second function, in order to attenuate an output value of the second function.

In this way, a superposition of the two functions takes place, which means that a flowing transition is generated between the functions. By way of an output value of the first function being used to damp the second function, binary activations are moreover avoided. That is to say, as soon as the dominating function becomes active, the output value of the second function goes toward zero and no longer has noteworthy influence on the reference variable of the control loop, the manual torque.

In one exemplary arrangement, the manual torque is composed at least of an end stop torque, which is based on the output value of the first, dominating function, and a regular damping torque, which is based on the output value of the second function. The regular damping torque always acts when the end stop damping torque is not active. For example, the regular damping torque compensates for the fact that a significantly lower system friction acts in a steer-by-wire steering system than in a conventional steering system. The end stop damping torque, in contrast, ensures that oversteering, thus a steering angle beyond the maximum steering angle, is avoided. By way of the output value of the first function being included as an input variable in the second function, in order to attenuate an output value of the second function, regular damping torque decreases as soon as an end stop torque acts. This means that predominantly either the regular damping torque or the end stop damping torque acts. However, a steering angle range exists in which the above-mentioned superposition takes place, that is to say an attenuated regular damping torque acts in addition to the end stop torque.

Because oversteering is prevented, transmission ratio errors between the steering angle of the steering wheel and the wheel steering angle are avoided. The maximum steering angle corresponds here to a maximum deflection of a servomotor on the front axle. Oversteering beyond the maximum steering angle is disadvantageous in particular because undesired reactions can occur, for example the absence of a steering reaction of the front axle.

The first function and the second function can have at least one common input signal. The output values of the functions thus have the same unit and can thus be added together, in order to form the reference variable for regulating the manual torque.

The common input signal of the first function and the second function is, for example, a steering angle and/or a steering wheel velocity and/or a steering wheel acceleration and/or a vehicle velocity. The damping may thus be adapted to a driving situation in this way. For example, at a high vehicle velocity, abrupt steering movements are to be avoided in order to ensure stable driving behavior, so that the damping torque also increases with increasing vehicle velocity. An increasing steering wheel acceleration in particular also causes increasing damping.

The output value of the first function causes, for example, a manual torque between +/−40 Nm and the output value of the second function causes a manual torque between +/−3 Nm. The first function can therefore cause significantly stronger damping than the second function, so that the first function is particularly suitable for causing an end stop damping torque, while the second function is particularly well suited to causing a regular damping torque.

According to one exemplary aspect, the output value of the first function acts on the second function in a manner multiplied by an amplification factor. The manual torque may thus be even better regulated, For example, if the amplification factor is greater than 1, even stronger attenuation of the output value of the second function is achieved. Alternatively, a deactivation of the superposition can take place if the amplification factor is set to the value zero.

The value of the amplification factor is, for example, stored in a profile. The value of the amplification factor can thus vary, for example, as a function of a vehicle velocity, a steering angle and/or a steering wheel acceleration.

According to one exemplary arrangement, an absolute value of the output variable of the second function is added to the output value of the first function acting as an input variable on the second function. Accordingly, a smooth transition between the first and the second function may be achieved. For example, the regular damping torque is applied again earlier when steering out of the end stop, thus before the end stop damping torque is reduced to zero.

In one example, a reciprocal of the sum of the output values is multiplied by the second function, wherein optionally the output value of the first function is amplified before the formation of the sum.

The output value of the first function is preferably zero at a steering angle in the range of at least +/−220°. In other words, the output value of the first function is zero if the steering wheel is not deflected by at least 220° starting from a neutral position. In this way, only the regular damping torque acts in the specified range.

The output value of the first function is increased for example, in one exemplary arrangement, exponentially increased, when the steering wheel position approaches a virtual end stop, The virtual end stop is, for example, at +/−220 to 270°, in particular at +1-250°. The manual torque increases due to an increase of the output value of the second function, by which oversteering is avoided. On the one hand, a clock spring engaging on the steering wheel is thus protected and, on the other hand, transmission ratio errors are efficiently avoided.

In one exemplary arrangement, the output value of the second function is amplified in the event of a decreasing output value of the first function. In this case, this is a local amplification upon leaving the range of the end stop. Such a local amplification has the advantage that when steering out of the range of the end stop, a sudden drop of the overall damping torque is avoided, which could have the result that the steering wheel suddenly snaps back in the direction of a neutral position. By way of the amplification only taking place in the event of a decreasing output value of the first function, the damping behavior is not influenced when steering into the range of the end stop.

To amplify the output value of the second function, an output value of the first function can be added with a time delay to the output value of the second function. Due to the time-delayed application, the local amplification still acts for a time when the range of the end stop has already been left.

The output value of the first function is optionally additionally multiplied by an amplification factor in order to define the level of the local amplification.

A steering system having a torque calculation unit, which is configured to determine a manual torque according to the method according to the disclosure, and having a torque generation unit, which is configured to provide the overall manual torque at a steering wheel of the steering system is also disclosed. As already explained in conjunction with the method according to the disclosure, binary activations and sudden increases of the overall damping torque may be avoided by use of the steering system according to the disclosure.

### BRIEF DESCRIPTION OF DRAWINGS

Further advantages and features of the disclosure result from the following description and from the appended drawings, to which reference is made. In the drawings:

FIG. 1 schematically shows a steer-by-wire steering system according to the disclosure,

FIG. 2 shows a block diagram to illustrate a general method for determining a manual torque,

FIG. 3 shows a block diagram to illustrate a method according to the disclosure for determining a regulated manual torque, and

FIG. 4 shows a block diagram to illustrate a further method according to the disclosure for determining a regulated manual torque.

### DETAILED DESCRIPTION

FIG. 1 schematically shows a steer-by-wire steering system 10 for a vehicle having a steering wheel 12.

The steering system 10 furthermore comprises a servomotor 14, which is arranged at a front axle 16.

The front axle 16 carries two front wheels 18, 20.

In a steer-by-wire steering system 10, there is no mechanical coupling between the steering wheel 12 and wheels 18, 20. Instead, a wheel steering angle is set by the servomotor 14.

The steering system 10 has a sensor 22, for example an angle sensor, which is used to detect a steering angle.

A signal is sent to a servomotor 4 based on the steering angle detected by the sensor 22.

More precisely, the steering system 10 has a control unit 24, which processes a value detected by the sensor 22 and sends a corresponding signal to the servomotor 14.

In addition, the steering system 10 has a torque calculation unit 26 and a torque generation unit 28.

The torque calculation unit 26 can be integrated in the control unit 24, as shown in FIG. 1. However, it is also conceivable that the torque calculation unit 26 is separate from the control unit 24.

The torque generation unit 28 is configured to provide a manual torque determined by the torque calculation unit 26 at the steering wheel 12.

The manual torque acts against a steering torque applied by a driver to the steering wheel 12. In this way, the absent mechanical coupling between the steering wheel 12 and the wheels 18, 20 is simulated.

The manual torque applied to the steering wheel 12 in particular enables stable steering behavior.

In an angle range of at least +/−220° around the neutral position of the steering wheel 12, a regular damping torque M_{Damping} acts, which is, for example, between +/−3 Nm. The sign is dependent here on a steering direction, thus whether the steering wheel 12 is rotated out of the neutral position or toward the neutral position. In this context, reference is also made to “steering out” in the case of a movement away from the neutral position and “steering in” in the case of a movement toward the neutral position.

The regular damping torque M_{Damping} is used to slow a steering movement.

For example, a steering wheel velocity, a steering wheel acceleration and/or a vehicle velocity are incorporated in the determination of the damping torque M_{Damping}.

When a position of the steering wheel 12 approaches an end stop, the steering angle moves in a range in which an end stop torque M_{End_stop} acts.

For example, a steering wheel velocity, a steering wheel acceleration, a vehicle velocity and/or a steering angle or possibly the degree of oversteering are incorporated in the determination of the end stop torque M_{End_stop}.

The end stop torque is significantly higher than the regular damping torque and is, for example, between +/−40 Nm.

The applied manual torque is limited by the power of a drive in the torque generation unit 28.

The end stop is, for example, at a steering angle between +/−220° and 270°. In one exemplary arrangement, the steering angle is at +/−250°. In steer-by-wire steering systems, reference is also made in this context to a virtual end stop, since the end stop is artificially generated by the torque generation unit 28.

In one exemplary arrangement, the end stop angle is adapted to a maximum movement path of the servomotor 14. That is to say, the end stop angle corresponds to a state in which the servomotor 14 is in a maximally moved position.

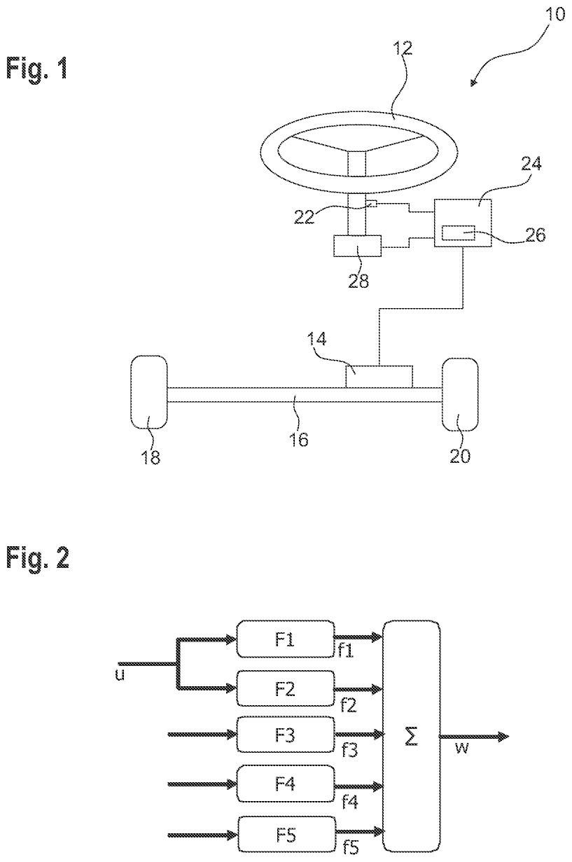

FIG. 2 illustrates an exemplary method for determining the manual torque on the basis of a block diagram.

For this purpose, the output values f1-f5 of multiple functions F1 to F5 are summed to form a reference variable w for a closed control loop. The reference variable w is the summed manual torque here.

The reference variable w has, for example, the unit Nm and directly specifies the absolute value of the torque, which is to be applied by torque generation unit 28 at the steering wheel 12.

For example, the end stop torque is based on the output value f1 of the first function F1.

For example, the regular damping torque is based on the output value f2 of the second function F2.

The functions F1 and F2 contain at least one common input signal u in the exemplary arrangement.

The common input signal u is, for example, a steering angle detected by the sensor 22, a steering wheel velocity, a steering wheel acceleration and/or a vehicle velocity.

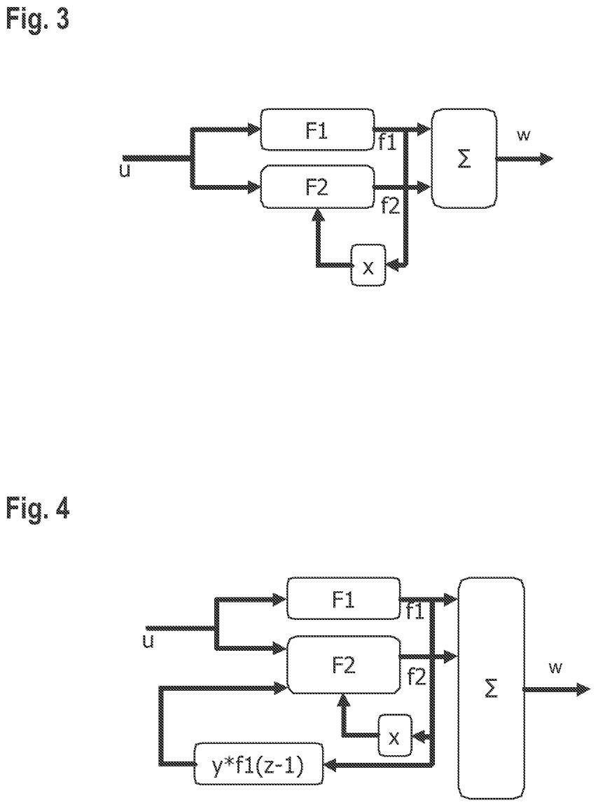

A method according to the disclosure is explained hereinafter on the basis of the block diagram in FIG. 3, For the sake of simplicity, only the functions F1 and F2 are discussed here. However, as also illustrated in FIG. 2, further functions can be added up to form the reference variable w.

FIG. 3 shows that an output value f1 of the first function F1 acts as an input variable or control variable on the second function F2, with the goal of attenuating an output value f2 of the second function F2, which is also explained hereinafter. In this way, superposition of the functions F1 and F2 is achieved.

The first function F1 is dominant over the second function F2. This means that the second function F2 is deactivated or at least significantly attenuated when the first function F1 is active.

The output value f1 of the first function F1 acting as an input variable on the second function F2 is additionally amplified by an amplification factor x in the exemplary arrangement.

A damped output value f2 of the second function F2 results, for example, by way of the following formula:

$${M}_{Damping \_ blend} = {M}_{Damping} * {min}_{1} \frac{1}{( - \vert {M}_{Damping} \vert + ( \vert {M}_{End \_ stop} \vert * {x}_{Amplification} ) )}$$

M_{Damping_blend} represents a damped output value f2 of the second function F2.

In the above formula, the regular damping torque M_{Damping} is multiplied by a quotient, which contains the absolute value of the end stop torque M_{End_stop} in the denominator. This absolute value is additionally amplified by an amplification factor X_{Amplification}. The damping torque is reduced even more strongly by the amplification.

The term −|M_{Damping}| optionally prefixed in the denominator ensures a smoother transition. For example, the regular damping torque M_{Damping} is thus applied again earlier when steering out of the range of the end stop, so that a reduction of the manual torque after an end stop is not as strong.

Since the absolute value of the end stop torque M_{End_stop} is significantly greater than 1 most of the time, the quotient results in a value of less than 1.

The amplification factor X_{Amplification} can also be used to deactivate superposition, in that the amplification factor X_{Amplification} is set to the value zero. In this case, M_{Damping-blend}=M_{Damping} results. min 1 prevents the quotient becoming less than 1 and thus causing undesired attenuation of the function F2.

FIG. 4 illustrates a further method for determining a manual torque.

The method illustrated in FIG. 4 is based on the method illustrated in FIG. 3. However, in the method according to FIG. 4, a local amplification of the second function F2 is additionally provided.

The local amplification is used to optimize a damping of the steering wheel when steering out of the range of the end stop.

While the steering wheel 12 is located in the range of the end stop, the end stop torque M_{End_stop} acts like a spring, which pre-tensions the steering wheel in the direction toward the neutral position.

When a driver loosens their grip on the steering wheel 12 or takes their hands off the steering wheel 12 in this state, the steering wheel 12 accelerates in the direction of the neutral position, similarly as in the case of snapping back.

This state is to be avoided by the method illustrated in FIG. 4.

For this purpose, during a transition out of the end stop range, the damping, for example, the second function F2, is locally amplified.

More precisely, the output value f1 of the first function F1 is added with a time delay as an amplification factor to the output value f2 of the second function F2. That is to say, at the point in time of the local amplification, the end stop torque M_{End_stop} is already inactive. The regular damping torque is active in amplified form.

The time delay can be implemented in various ways here, for example, by a PT1 element or a PT2 element.

In this way, a sufficiently strong counter-torque is generated by the second function F2 in the case of a rapid, sudden exit from the end stop range.

In the exemplary arrangement, the local amplification is implemented by the element G=y*f1(z−1). z designates the time delay. y represents an amplification factor, which defines the level of the local amplification.

The amplification factor y can optionally be set to zero to deactivate the local amplification.

The output value f2 of the second function F2 thus results in the method illustrated in FIG. 4 by way of the formula

f2=(u*(F2+y*G(f1))/f1+x

The local amplification only acts upon exiting the end stop range, the damping behavior is unchanged upon entry into the end stop range, thus as in the method illustrated in FIG. 3.

1. A method for determining a regulated manual torque for a steer-by-wire steering system, which works against a steering torque applied by a driver to a steering wheel, the method comprising regulating the manual torque as a reference variable, which results from summed output values of at least two functions, wherein a first function of the at least two functions is dominant over a second function of the at least two functions, and wherein an output value of the first, dominant function acts as an input variable on the second function, in order to attenuate an output value of the second function.

2. The method as claimed in claim 1, wherein that the manual torque is composed at least of an end stop torque (M_{End_stop}), which is based on the output value (f1) of the first, dominant function (F1), and a regular damping torque (M_{Damping}), which is based on the output value (f2) of the second function (F2).

3. The method as claimed in claim 1, wherein the first function and the second function have at least one common input signal.

4. The method as claimed in claim 3, wherein the common input signal of the first function and the second function is a steering angle and/or a steering wheel velocity and/or a steering wheel acceleration and/or a vehicle velocity.

5. The method as claimed in claim 1, wherein the output value of the first function causes a damping torque between +/−40 Nm and the output value of the second function causes a damping torque between +/−3 Nm.

6. The method as claimed in claim 1, wherein the output value of the first function acts on the second function in a manner multiplied by an amplification factor.

7. The method as claimed in claim 1, wherein an absolute value of the output variable of the second function is added to the output value of the first function acting as an input variable on the second function.

8. The method as claimed in claim 1, wherein the output value of the first function is zero at a steering angle of at least +/−220°.

9. The method as claimed in claim 1, wherein the output value of the first function is increased when the steering wheel position approaches a virtual end stop.

10. The method as claimed in claim 1, wherein the output value of the second function is amplified in the event of a decreasing output value of the first function.

11. The method as claimed in claim 10, to amplify the output value of the second function, an output value of the first function is added with a time delay to the output value of the second function.

12. A steering system having a torque calculation unit, which is configured to determine a manual torque according to the method as claimed in claim 1, and having a torque generation unit, which is configured to provide the manual torque at a steering wheel of the steering system.

13. The method as claimed in claim 2, wherein the first function and the second function have at least one common input signal.

14. The method as claimed in claim 13, wherein the common input signal of the first function and the second function is a steering angle and/or a steering wheel velocity and/or a steering wheel acceleration and/or a vehicle velocity.

15. The method as claimed in claim 14, wherein the output value of the first function causes a damping torque between +/−40 Nm and the output value of the second function causes a damping torque between +/−3 Nm.

16. The method as claimed in claim 14, wherein the output value of the first function acts on the second function in a manner multiplied by an amplification factor.

17. The method as claimed in claim 14, wherein an absolute value of the output variable of the second function is added to the output value of the first function acting as an input variable on the second function.

18. The method as claimed in claim 14, wherein the output value of the first function is zero at a steering angle of at least +/−220°.

19. The method as claimed in claim 14, wherein the output value of the first function is exponentially increased when the steering wheel position approaches a virtual end stop.

20. The method as claimed in claim 14, wherein the output value of the second function is amplified in the event of a decreasing output value of the first function.
